(19) United States
(12) Patent Application Publication
(10) Pub. No.: US 2025/0247366 A1
(43) Pub. Date: Jul. 31, 2025

(54) DISTRIBUTED FIREWALL DEFINITION METHOD AND SYSTEM

(71) Applicant: INSPUR SUZHOU INTELLIGENT TECHNOLOGY CO., LTD., Suzhou, Jiangsu (CN)

(72) Inventors: Tongjian ZHANG, Suzhou, Jiangsu (CN); Haizhong QIN, Suzhou, Jiangsu (CN)

(21) Appl. No.: 18/565,058

(22) PCT Filed: Jan. 27, 2022
(86) PCT No.: PCT/CN2022/074415

§ 371 Date: Jun. 19, 2024

(30) Foreign Application Priority Data
Oct. 9, 2021 (CN) 202111173614.6

(51) Int. Cl. H04L 9/40

(52) U.S. Cl. CPC H04L 63/0263; H04L 63/0218

(57) ABSTRACT

The present application provides method for defining distributed firewall and electronic device. The method comprises: monitoring, by firewall assembly, firewall event in real time, and sending firewall configuration data corresponding to currently monitored firewall event to OVN database; converting, by the OVN database, the firewall configuration data into corresponding strategy route, performing processing corresponding to the firewall event on the data stored in the OVN database according to the strategy route, and sending, changed data in the data stored in the OVN database caused by performing processing corresponding to the firewall event on the data stored in the OVN database to OVN controllers located on every compute node respectively; and sending, by the OVN controller, the received data to an OVS daemon module on the compute node that the OVN controller is located, and storing, by the OVS daemon module, the received data in memory to realize forwarding a message.

This application claims priority to and benefits of Chinese Patent Application Serial No. 202111173614.6, and the title of “method for defining a distributed firewall and system” filed with the State Intellectual Property Office of P. R. China on Oct. 9, 2021, the entire content of which is incorporated herein by reference.

### FIELD

The present disclosure relates to the technical field of firewall and, more particularly, to a method for defining a distributed firewall and system.

### BACKGROUND

The rapid development of Openstack (an open source framework, applied in the field of cloud computing) cloud computing brings advantages of resource integration, as well as more use risks, for example a problem of a bottleneck of network bandwidth. For the problem of network bandwidth, various methods of speed limiting or traffic filtering and shunting are generally used to solve it, but the network threats faced by these methods are larger. How to realize the reasonable allocation of network bandwidth appropriately and efficiently and ensure network security is an unavoidable problem at present.

At present, in an application scenario of deploying a private cloud platform based on the Openstack framework, the control of a data package entering and exiting a virtual network is generally realized by adding iptables (ip rule table) rules to a native Virtual Router of Openstack. By adding the iptables rules on the native Virtual Router, the filtering of the traffic is concentrated on L3agent, when the traffic is suddenly increased, security protection isolation may not be realized, and network problems for example network congestion and the like may also occur at the same time.

### SUMMARY

The purpose of the present application is to provide a method for defining a distributed firewall and system, which may realize security protection isolation and avoid network problems for example network congestion.

In order to realize the above-mentioned purpose, the present application provides the following technical solutions:

A method for defining a distributed firewall, including:
monitoring, by a firewall assembly, a firewall event in real time, and sending firewall configuration data corresponding to a currently monitored firewall event to an Open Virtual Network (OVN) database;
converting, by the OVN database, the firewall configuration data into a corresponding strategy route, performing processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively;
sending, by the OVN controller, the received data to an open v switch (OVS) daemon module on the compute node that the OVN controller is located, and storing, by the OVS daemon module, the received data in a memory to realize forwarding a message.

According to an embodiment, before the step of, sending, by the firewall assembly, the firewall configuration data corresponding to the currently monitored firewall event to the OVN database, the method further includes:
determining, by the firewall assembly, that the currently monitored firewall event is a firewall creation event, and judging whether a firewall strategy, a firewall strategy rule and an associated router of the firewall corresponding to the firewall creation event exist in a network server,
if yes, extracting various parameter data required for constructing the corresponding strategy route based on the firewall strategy, the firewall strategy rule and the associated router corresponding to the firewall creation event, and determining the extracted parameter data as the corresponding firewall configuration data, if no, exiting the processing of the firewall creation event;
correspondingly, the step of, performing, by the OVN database, processing corresponding to the firewall event on the data stored in the OVN database according to the strategy route, including:
storing the strategy route by the OVN database.

According to an embodiment, after the step of, determining, by the firewall assembly, that the firewall strategy, the firewall strategy rule and the associated router of the firewall corresponding to the firewall creation event exist in the network server, the method further includes:
traversing, by the firewall assembly, the associated routers of the firewall corresponding to the firewall creation event, and when traversing to any associated router, creating a preset default firewall strategy rule under the associated router.

According to an embodiment, before the step of, storing the strategy route by the OVN database, the method further includes:
judging, by the OVN database, whether the OVN database stores a strategy route, if yes, refreshing the stored strategy route by using the currently converted strategy route, otherwise, executing the step of storing the strategy route.

According to an embodiment, after the step of, determining, by the firewall assembly, the extracted parameter data as the corresponding firewall configuration data, the method further includes:
setting, by the firewall assembly, the status of the firewall corresponding to the firewall creation event as an effective status, and synchronizing the datum that the firewall corresponding to the firewall creation event is in the effective status to the network server for realizing the use of the firewall corresponding to the firewall creation event.

According to an embodiment, before the step of, sending, by the firewall assembly, the firewall configuration data corresponding to the currently monitored firewall event to the OVN database, the method further includes:
determining, by the firewall assembly, that the currently monitored firewall event is a firewall deletion event, and obtaining a firewall strategy, a firewall strategy rule and a router of the firewall corresponding to the firewall deletion event from the network server, based on the obtained firewall strategy, firewall strategy rule and router corresponding to the firewall deletion event, constructing parameter data required for constructing the corresponding strategy route, and determining the extracted parameter data as the corresponding firewall configuration information;
correspondingly, the step of, performing, by the OVN database, processing corresponding to the firewall event on the data stored in the OVN database by using the strategy route, including:
deleting the data stored by the OVN database that is the same as the strategy route by the OVN database.

According to an embodiment, before the step of, sending, by the firewall assembly, the firewall configuration data corresponding to the currently monitored firewall event to the OVN database, the method further includes:
determining, by the firewall assembly, that the currently monitored firewall event is a firewall update event, and comparing the firewall strategy rules corresponding to the firewall update event in the network server and the OVN database respectively, when it is determined that a firewall strategy rule needs to be added to the OVN database based on the comparison result, performing correspondingly processing for the firewall creation event according to the currently monitored firewall event; and when it is determined that the firewall strategy rule needs to be deleted from the OVN database based on the comparison result, performing correspondingly processing for the firewall deletion event according to the currently monitored firewall event.

According to an embodiment, the step of, sending, by the firewall assembly, the firewall configuration data corresponding to the currently monitored firewall event to the OVN database, including:
sending the firewall configuration data corresponding to the currently monitored firewall event to an OVN northbound database by the firewall assembly, and by the OVN northbound database, converting the firewall configuration data into a corresponding strategy route, performing processing corresponding to the firewall event on the data stored by the OVN northbound database according to the strategy route, and after monitoring that the data stored in the OVN northbound database change, by a daemon process of the OVN northbound database, sending the changed data in the OVN northbound database to an OVN southbound database, to instruct the OVN southbound database to store the received data, and send the changed data in the OVN south database to the OVN controller thereafter.

According to an embodiment, before the step of, sending, by the firewall assembly, the firewall configuration data corresponding to the currently monitored firewall event to the OVN database, the method further includes:
converting, by the firewall assembly, the firewall configuration data corresponding to the currently monitored firewall event into a rule code that capable to be recognized by an OVN driver corresponding to the OVN database;
the step of, converting, by the OVN database, the firewall configuration data into the corresponding strategy route, including:
converting, by the OVN northbound database, the firewall configuration data into a corresponding strategy route; before the step of, storing the received data by the OVN southbound database, the method further includes:
converting, by the OVN southbound database, the received data into a logical flow table; and before the step of, storing the received data in the memory by the OVS daemon module, the method further includes:
parsing the received data into an OVS physical flow table by the OVN daemon module.

According to an embodiment, before the step of, the firewall assembly, the OVN northbound database, the OVN southbound database and the OVN controller sending the data required to be sent, the method further includes:
encapsulating the data required to be sent into an OVSDB message format.

The present application further provides a system for defining a distributed firewall, including:
a firewall assembly, configured for monitoring a firewall event in real time, and sending firewall configuration data corresponding to a currently monitored firewall event to an OVN database;
an OVN database, configured for converting the firewall configuration data into a corresponding strategy route, performing processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively;
the OVN controller, configured for sending the received data to an OVS daemon module on the compute node that the OVN controller is located;
the OVS daemon module, configured for storing the received data in a memory to realize forwarding a message.

The present application provide a method for defining a distributed firewall and system, the method includes: monitoring, by a firewall assembly, a firewall event in real time, and sending firewall configuration data corresponding to a currently monitored firewall event to an OVN database; converting, by the OVN database, the firewall configuration data into a corresponding strategy route, performing, processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively; sending, by the OVN controller, the received data to a OVS daemon module on the compute node that the OVN controller is located, and storing, by the OVS daemon module, the received data in a memory to realize forwarding a message. According to the present application, by the firewall assembly, after monitoring the firewall event in real time, sending the firewall configuration data corresponding to the currently monitored firewall event to the OVN database. By the OVN database, after converting the firewall configuration data into the corresponding strategy route, performing processing corresponding to the firewall event on the data stored in the OVN database according to the strategy route, and sending changed data in the data stored in in the OVN database caused by performing processing corresponding to the firewall event on the data stored in the OVN database to OVN controllers located on every compute node respectively. By the OVN controller, sending the received data to the OVS daemon module on the compute node that the OVN controller is located, and by the OVS daemon module, storing the received data in a memory to realize forwarding the message. It may be seen that, according to the present application, a distributed firewall function is implemented on the basis of the strategy route driven by the OVN, which is different from the centralized processing of firewall traffic in the conventional technologies, so that security protection isolation is realized, and network problems for example network congestion and the like may be avoided at the same time.

### BRIEF DESCRIPTION OF THE DRAWINGS

In order to illustrate the specific embodiments of the present application or the technical solutions in the conventional technologies more clearly, the drawings that are needed in the description of the specific embodiments or the conventional technologies will be briefly introduced below. Apparently, the drawings in the following description are some embodiments of the present application, and other drawings may be obtained according to these drawings without creative work for a person skilled in the art.

FIG. 1 is a flowchart of the method for defining the distributed firewall provide by an embodiment of the present application.

FIG. 2 is a schematic diagram of the default firewall strategy rule in the method for defining the distributed firewall provided by an embodiment of the present application.

FIG. 3 is a structural schematic diagram of a device for defining the distributed firewall provided by an embodiment of the present application.

### DETAILED DESCRIPTION

In the following, the technical solutions in the embodiments of the present application will be clearly and completely described below with reference to the drawings in the embodiments of the present application. Apparently, the described embodiments are merely a portion of the embodiments of the present application, but not all the embodiments. Based on the embodiments in the present application, all other embodiments obtained by a person skilled in the art without creative efforts shall fall within the protection scope of the present application.

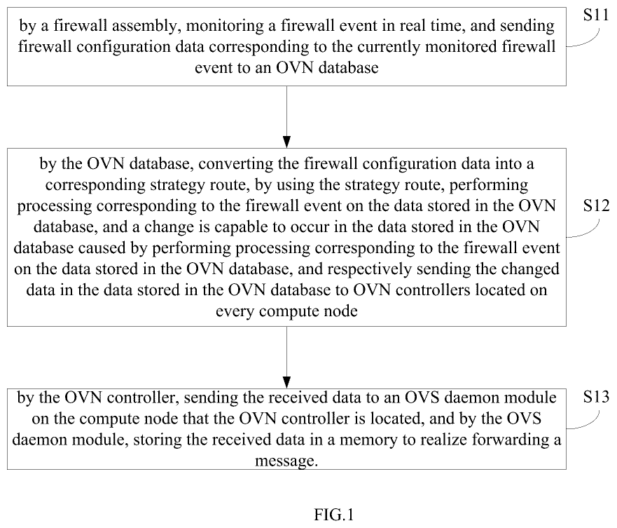

Please refer to FIG. 1, which shows a flowchart of the method for defining the distributed firewall provide by an embodiment of the present application, the method may include:

S11, by a firewall assembly, monitoring, by a firewall assembly, a firewall event in real time, and sending firewall configuration data corresponding to a currently monitored firewall event to an OVN database.

According to the embodiment of the present application, the method for defining the distributed firewall may be realized by the software definition of an Openstack multi-architecture. In a cluster environment of the Openstack multi-architecture, the software defined distributed firewall function is realized by loading the strategy route program in an OVN driver by using an underlying driver of the firewall plug-in loaded by a Neutron assembly of the OpenStack multi-architecture. Wherein, receiving, by the Neutron-Fwaas plug-in (firewall assembly) the firewall-related configuration and firewall events from Neutron (the network core assembly in Openvswitch), for example, a firewall creation event, a firewall deletion event, a firewall update event, a firewall association strategy, a firewall association rule, and a firewall associated router (the router in the embodiment of the present application may be a virtual router), and so on. After every time the firewall event is monitored the configuration corresponding to the currently monitored firewall event (the firewall configuration data are data representing the corresponding configuration of the firewall event) is sent to the OVN database.

In addition, the method for defining the distributed firewall in the embodiment of the present application is actually that after the firewall configuration is actually implemented by an external user or other personnel, the implemented firewall configuration is deployed to the OVS-Vswitchd (OVS daemon module) by means of the OVN database, to make the OVS-Vswitchd implements the subsequent message forwarding based on the implemented firewall configuration, so that the network traffic is controlled.

S12, converting, by the OVN database, the firewall configuration data into a corresponding strategy route, performing, processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively.

By the OVN database, after receiving the firewall configuration data, converting the currently received firewall configuration data into the corresponding strategy route, performing processing corresponding to the firewall event on the data stored in the OVN database according to the strategy route. When the firewall event is a firewall creation event, the strategy route will be stored in the OVN database; when the firewall event is a firewall deletion event, the strategy route will be deleted from the OVN database; when the firewall event is a firewall update event, the corresponding data in the OVN database will be updated by using the strategy route. After the OVN database processes its own stored data by using the strategy route converted from the firewall configuration data, the OVN database may determine the changed data in the OVN database caused by performing processing corresponding to the firewall event on the data stored in the OVN database, and send the changed data to the OVN controllers located on every compute node, so that every OVN controller may send the changed data to the OVS daemon module on the compute node that the OVN controller is located. Consequently, the OVS daemon module may store the received data for subsequent message forwarding, so that the deployment that the firewall event is correspondingly configured to the OVS daemon module located on every node is realized, that is, the distributed definition of the firewall is realized.

S13, sending, by the OVN controller, the received data to an OVS daemon module on the compute node that the OVN controller is located, and storing, by the OVS daemon module, the received data in a memory to realize forwarding a message.

In the present application, after the firewall assembly monitoring the firewall event, sending the firewall configuration data corresponding to the monitored firewall to the OVN database, and after the OVN database converting the firewall configuration data corresponding to the firewall configuration event into the strategy route, the OVN database performs processing corresponding to the firewall event on the data stored in the OVN database by using the strategy route, and sends the changed data in the data stored in the OVN database caused by the processing to OVN controllers located at every compute node. The OVN controller forwards the received data to the OVS daemon module on the compute node that the OVN controller is located, to make the OVS daemon module storing the received data for realizing subsequent message forwarding. It may be seen that, in the present application, the distributed firewall function is implemented on the basis of the strategy route driven by the OVN, which is different from the centralized processing of firewall traffic in the conventional technologies, so that security protection isolation is realized, and network problems for example network congestion and the like may be avoided at the same time.

The method for defining the distributed firewall provide by an embodiment of the present application, the step of, sending, by the firewall assembly, the firewall configuration data corresponding to the currently monitored firewall event to the OVN database may include:
sending, the firewall configuration data corresponding to the currently monitored firewall event to an OVN northbound database by the firewall assembly, and by the OVN northbound database, converting the firewall configuration data into a corresponding strategy route, performing processing corresponding to the firewall event on the data stored by the OVN northbound database according to the strategy route, and after monitoring that the data stored in the OVN northbound database changes, by a daemon process of the OVN northbound database, sending the changed data in the OVN northbound database to an OVN southbound database, to instruct the OVN southbound database to store the received data, and send the changed data in the OVN south database to the OVN controller thereafter.

Before the step of, sending, by the firewall assembly, the firewall configuration data corresponding to the currently monitored firewall event to the OVN database, the method may further include:
converting, by the firewall assembly, the firewall configuration data corresponding to the currently monitored firewall event into a rule code that capable to be recognized by an OVN driver corresponding to the OVN database;
the step of, converting, by the OVN database, the firewall configuration data into the corresponding strategy route, including:
converting, by the OVN northbound database, the firewall configuration data into a corresponding strategy route; before the step of, storing the received data by the OVN southbound database, the method further includes:
converting, by the OVN southbound database, the received data into a logical flow table; and before the step of, storing the received data in the memory by the OVS daemon module, the method further includes:
parsing the received data into an OVS physical flow table by the OVN daemon module.

Before the step of, the firewall assembly, the OVN northbound database, the OVN southbound database and the OVN controller sending the data required to be sent, the method further comprises:
encapsulating the data required to be sent into an OVSDB message format.

It should be noted that, in the embodiment of the present application, after the Neutron-Fwaas plug-in monitors the firewall event, converting the firewall configuration data corresponding to the monitored firewall event into a rule code that may be recognized by the OVN driver. After encapsulating the converted rule code into an OVSDB message format, by an OVSDB client end, sending a message to the OVN northbound database (OVN Northbound DB). After receiving the message, parsing the message content and converting it into a regular format of the strategy route by the OVN Northbound DB, and storing the message into the OVN Northbound DB. At the same time, when the daemon process (OVN Northbound Daemon) monitoring that the data in OVN Northbound DB is changed, encapsulating the changed data in the OVN Northbound DB into the OVSDB message format and sending it to the OVN Southbound Database (OVN Southbound DB). After the OVN Southbound DB receiving the message, parsing the message, and converting the firewall related configuration into a logical flow table and storing it in the OVN Southbound DB, and sending a synchronous OVSDB message to the OVN controller (OVN Control) at the same time. In this point, after OVN Control servers on every compute node monitoring the change of the OVN Southbound DB data, receiving the message and parsing the content of the message into OVS-Vswitchd. The OVS-Vswitchd may parse the received message into an OVS physical flow table and store it in a memory for subsequent message forwarding, so that the network traffic is effectively controlled.

Wherein, the rule code that the OVN driver capable to recognize is the data format that the OVN Northbound DB capable to recognize, that is, the data format that the strategy route capable to recognize, and converting the firewall configuration data into the corresponding strategy route maybe that extracting data required for the strategy route from the firewall configuration data, for example an IP, a mac, a port, a protocol and an action and the like, and assembling these data in the way required by the strategy route, to complete the conversion from the firewall configuration data to the corresponding strategy route. In addition, the physical flow table and the logical flow table have the same meaning as the corresponding concepts in the conventional technologies, and the physical flow table and the logical flow table are in a corresponding relationship. The physical flow table is realized by a flow table format of Open Flow, and the logical flow table exists in the form of Logical Flow. The biggest difference between them is that the Logical Flow describes the behavior of the entire network in detail and may be extended to any number of hosts, while the Open Flow is effective for the host of the present node. In the embodiment of the present application, the OVN database edits the network by means of the logical flows, and these logical flows may be distributed to every machine operating in the OVN Control, and the OVN Control compiles these logical flows into the Open Flow according to the current physical environment (where the local port is and how to get to other machines, and so on).

The method for defining the distributed firewall provide by an embodiment of the present application, before the step of, sending, by the firewall assembly, the firewall configuration data corresponding to the currently monitored firewall event to the OVN database, the method further includes:
determining, by the firewall assembly, that the currently monitored firewall event is a firewall creation event, and judging whether a firewall strategy, a firewall strategy rule and an associated router of the firewall corresponding to the firewall creation event exist in a network server; if yes, extracting various parameter data required for constructing the corresponding strategy route based on the firewall strategy, the firewall strategy rule and the associated router corresponding to the firewall creation event, and determining the extracted parameter data as the corresponding firewall configuration data, if no, exiting the processing of the firewall creation event;
correspondingly, the step of, performing, by the OVN database, processing corresponding to the firewall event on the data stored in the OVN database according to the strategy route, including:
storing the strategy route by the OVN database.

After the step of, determining, by the firewall assembly, that the firewall strategy, the firewall strategy rule and the associated router of the firewall corresponding to the firewall creation event exist in the network server, the method further includes:
traversing, by the firewall assembly, the associated routers of the firewall corresponding to the firewall creation event, and when traversing to any associated router, creating a preset default firewall strategy rule under the associated router when traversing to any associated router.

Before the step of, storing the strategy route by the OVN database, the method further includes:
judging, by the OVN database, whether the OVN database stores a strategy route, if yes, refreshing the stored strategy route by using the currently converted strategy route, otherwise, executing the step of storing the strategy route.

After the step of, determining, by the firewall assembly, the extracted parameter data as the corresponding firewall configuration data, the method further includes:
setting, by the firewall assembly, the status of the firewall corresponding to the firewall creation event as an effective status, and synchronizing the datum that the firewall corresponding to the firewall creation event is in the effective status to the network server for realizing the use of the firewall corresponding to the firewall creation event.

In the present embodiment, the Neutron-Fwaas-plugin in the neutron-fwaas plug-in registers a firewall event monitoring mechanism, for example a firewall creation event, a firewall deletion event and a firewall update event. In addition, a function code of OVN firewall driver handler is added in the Neutron-Fwass plug-in, to monitor the firewall event by the OVN Firewall Driver Hander. In response to that the OVN Firewall Driver Hander monitors the firewall creation event, the process of executing the corresponding deployment of the firewall creation event may include:
determining whether an external user or other personnel has completed the configuration of the firewall corresponding to the firewall creation event: confirming whether the firewall strategy (that is, the firewall strategy corresponding to the firewall creation event) transmitted by the Neutron Server exists in the network server of the system, in response to yes, continuing to execute, otherwise, exiting. After confirming that the firewall strategy exists in the network server, confirming whether the firewall strategy rule of the firewall strategy exists in the network server, if yes, continuing to execute, otherwise, exiting. After confirming that the firewall strategy rule exists in the network server, confirming whether the router associated with the firewall corresponding to the firewall creation event exists, if yes, continuing to execute, otherwise, exiting.

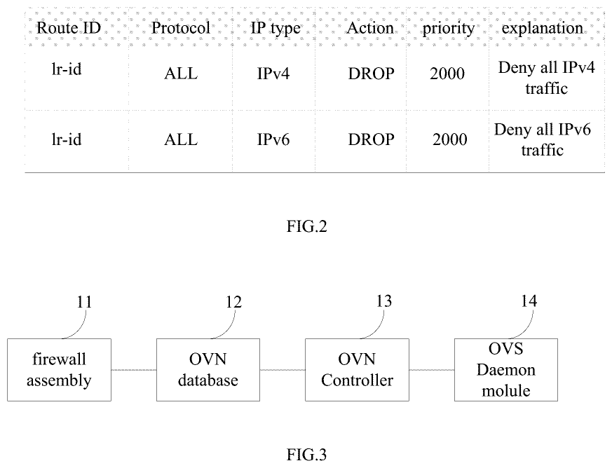

When the firewall strategy, the firewall strategy rule and the associated router corresponding to the firewall creation event all exist, traversing the routers associated with the firewall corresponding to the firewall creation event (the data of the associated router may be stored in a router list), and creating two default firewall strategy rules as shown in FIG. 2 under every router, to ensure that every router has a unified firewall strategy that the system needs to be set for it. Thereafter based on the firewall strategy, the firewall strategy rule and the associated router corresponding to the firewall creation event, extracting data required to construct the corresponding strategy route, for example a protocol number, a port number, an ip address, an action, and so on, and taking these data as the corresponding firewall configuration data, and invoking an OVN Client to send a request to add the strategy route to the OVN driver. After that the OVN database converts the firewall configuration data into the correspond strategy route and stores it, transmitting backwards the data changes caused by the stored strategy route sequentially, until the OVS daemon module stores the physical flow table corresponding to the strategy route for forwarding subsequent messages. At the same time, the status of the firewall corresponding to the firewall creation event will be set to be ACTIVE (an effective state), and updating to a Marildb database of the Neutron (network server) synchronously, so that operations for example the use of the corresponding firewall may be ensured.

In addition, before the OVN database needs to store the strategy route, it may also judge whether this entry already exists in the OVN database. In response to that this entry exists, the existing entry will be refreshed by using the strategy route obtained by the current conversion. In response to that this entry does not exist, storing the strategy route obtained by the current conversion, and the currently stored strategy route will be associated with the ID of the associated router in the OVN database, so that ensuring that the data stored in the OVN database is effective.

The method for defining the distributed firewall in an embodiment of the present application, before the step of, sending, by the firewall assembly, the firewall configuration data corresponding to the currently monitored firewall event to the OVN database, the method further includes:
by the firewall assembly, determining that the currently monitored firewall event is a firewall deletion event, and obtaining a firewall strategy, a firewall strategy rule and a router of the firewall corresponding to the firewall deletion event from the network server, based on the obtained firewall strategy, firewall strategy rule and router corresponding to the firewall deletion event, constructing parameter data required for constructing the corresponding strategy route, and determining the extracted parameter data as the corresponding firewall configuration information;
correspondingly, the step of, performing, by the OVN database, processing corresponding to the firewall event on the data stored in the OVN database according to the strategy route, including:
deleting the data stored by the OVN database that is the same as the strategy route by the OVN database.

It should be noted that, in the embodiment of the present application, when the OVN Firewall Driver Hander monitors the firewall deletion event, the process of executing the deletion may include:

Traversing the router associated with the firewall corresponding to the firewall deletion event (which may be realized by traversing the router list), and constructing data related to the strategy route based on the firewall strategy, the firewall strategy rule and the associated router corresponding to the firewall deletion event, and taking these data as the corresponding firewall configuration data. Subsequently invoking an OVN Client to send a request to an OVN driver to make the OVN database realize corresponding firewall deployment based on the firewall configuration data. Correspondingly, after the OVN database receiving the firewall configuration data and converting the firewall configuration data into the corresponding strategy route, the strategy route obtained by the current conversion existing under the traversed routers may be directly deleted, and the default firewall strategy rules under these routers may also be deleted, and transmitting backwards the changed data caused by the deletion strategy route and the default firewall strategy rule sequentially, until the OVS daemon module deletes the corresponding physical flow table, so that the firewall is effectively and quickly deleted.

The method for defining the distributed firewall in an embodiment of the present application, before the step of, sending, by the firewall assembly, the firewall configuration data corresponding to the currently monitored firewall event to the OVN database, the method further includes:
determining, by the firewall assembly, that the currently monitored firewall event is a firewall update event, and comparing the firewall strategy rules corresponding to the firewall update event in the network server and the OVN database respectively, when it is determined that a firewall strategy rule needs to be added to the OVN database based on the comparison result, performing correspondingly processing for the firewall creation event according to the currently monitored firewall event; and when it is determined that the firewall strategy rule needs to be deleted from the OVN database based on the comparison result, performing correspondingly processing for the firewall deletion event according to the currently monitored firewall event.

If the OVN Firewall Driver Hander monitor the firewall update event, the process of executing the update may include:

Comparing the firewall strategy rule in the network server corresponding to the firewall update event with the firewall strategy rule in the OVN database. When a firewall strategy rule exists in the network server but not exists in the OVN database, it means that this firewall strategy rule needs to be added to the OVN database, consequently, performing corresponding processing according to the firewall creation event. In this point, the firewall corresponding to the firewall strategy rule is the firewall corresponding to the firewall creation event, to realize the subsequent firewall creation operation. When a firewall strategy rule stored in the OVN database but not in the network server, it means that the firewall strategy needs to be deleted from the OVN database, to perform corresponding processing according to the firewall deletion event. In this point, the firewall corresponding to the firewall strategy rule is the firewall corresponding to the firewall deletion event, to realize the subsequent firewall deletion operation. When the firewall strategy rules in the two are the same, it is determined that the corresponding firewall deployment does not need to be implemented, to effectively realize the firewall update event in this way.

To sum up, according to the present application, in the multi-architecture cluster environment deployed by the Openstack, the strategy route in OVN driver is used for realizing the distributed firewall service. The user is associated with the router by issuing a firewall strategy rule, and the firewall strategy rule takes effect in every interface in the virtual router. Since it is realized based on the OVN, the underlying layer of the OVN replaces all the agents about the Neutron in the original Openstack architecture, and uniformly issuing the OVN flow table by means of the OVSDB protocol to realize communication and traffic forwarding, so that the problems of resource loss and data synchronization management caused by the interaction between the Neutron Server and each of the agents is reduced. Moreover, the implementation of the OVN is a distributed architecture, so the firewall realized based on this is also a distributed firewall. When a virtual machine tenant network passes through the router across the network segment, the traffic does not need to be uniformly forwarded to the network node or the control node for processing, and the three-layer traffic forwarding rules may be completed at the present node, thus avoiding the bandwidth bottleneck caused by centralized processing in L3agent of the network node or the control node. At the same time, the firewall rule is associated with the router, and when all users issuing the firewall rule, it may also take effect on every node, so that the performance bottleneck problem caused by the centralized processing of the original firewall is avoided, high performance forwarding of the three-layer network and high performance service of the distributed firewall is achieved, the security protection strategy in the distributed control of every cluster by the virtual machine networking network may be obtained, and the network security problem may be effectively isolated. The network security problem is circumvented to a certain node, to prevent the damage of the entire cluster, the practicability of the user is enhanced, and make the firewall security strategy in the OpenStack cloud environment being more elastically expanded. That is, the firewall realized based on the strategy route of the OVN in the present application is a distributed firewall. For an Openstack multi-architecture cluster, the management and control of the traffic is more flexible, the problem positioning of network traffic is more accurate, and for traffic limitations of some burst bandwidths, higher performance may be achieved, which makes the isolation of the virtual machine network and physical network safer.

An embodiment of the present application further provides a distributed firewall definition system, as shown in FIG. 3, the system includes:
a firewall assembly 11, configured for monitoring a firewall event in real time, and sending firewall configuration data corresponding to a currently monitored firewall event to an OVN database;
an OVN database 12, configured for converting the firewall configuration data into a corresponding strategy route, performing processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively;
the OVN controller 13, configured for sending the received data to an OVS daemon module on the compute node that the OVN controller is located;
the OVS daemon module 14, configured for storing the received data in a memory to realize forwarding a message.

It should be noted that, for the description of relevant portions in the system for defining the distributed firewall provided by the embodiment of the present application, please refer to the detailed description of corresponding portions in the method for defining the distributed firewall provided by the embodiment of the present application, and will not be repeated herein. In addition, the portion of the technical solution provided by the embodiment of the present application that is consistent with the realization principle of the corresponding technical solution in the conventional technologies is not described in detail, to avoid redundant description.

The above description of the disclosed embodiments enables a person skilled in the art to make or use the invention of the present application. Various modifications to these embodiments will be obvious to a person skilled in the art. The general principles defined herein may be implemented in other embodiments without departing from the spirit or scope of the present application. Consequently, the present application will not be limited to the embodiments shown herein, but is to be accorded the widest scope consistent with the principles and novel features disclosed herein

1. A method for defining a distributed firewall, comprising:
monitoring, by a firewall assembly, a firewall event in real time, and sending firewall configuration data corresponding to a currently monitored firewall event to an open virtual network (OVN) database;
converting, by the OVN database, the firewall configuration data into a corresponding strategy route, performing processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively;
sending, by the OVN controller, the received data to an open v switch (OVS) daemon module on the compute node that the OVN controller is located, and storing, by the OVS daemon module, the received data in a memory to realize forwarding a message.

2. The method according to claim 1, wherein before the step of, sending, by the firewall assembly, the firewall configuration data corresponding to the currently monitored firewall event to the OVN database, the method further comprises:
determining, by the firewall assembly, that the currently monitored firewall event is a firewall creation event, and determining whether a firewall strategy, a firewall strategy rule and an associated router of the firewall corresponding to the firewall creation event exist in a network server,
if yes, extracting various parameter data required for constructing the corresponding strategy route based on the firewall strategy, the firewall strategy rule and the associated router corresponding to the firewall creation event, and determining the extracted parameter data as the corresponding firewall configuration data, if no, exiting the processing of the firewall creation event;
correspondingly, the step of, performing, by the OVN database, processing corresponding to the firewall event on the data stored in the OVN database according to the strategy route, comprising:
storing the strategy route by the OVN database.

3. The method according to claim 2, wherein after the step of, determining, by the firewall assembly, that the firewall strategy, the firewall strategy rule and the associated router of the firewall corresponding to the firewall creation event exist in the network server, the method further comprises:
traversing, by the firewall assembly, the associated routers of the firewall corresponding to the firewall creation event, and when traversing to any associated router, creating a preset default firewall strategy rule under the associated router.

4. The method according to claim 3, wherein before the step of, storing the strategy route by the OVN database, the method further comprises:
determining, by the OVN database, whether the OVN database stores a strategy route, if yes, refreshing the stored strategy route by using the currently converted strategy route, otherwise, executing the step of storing the strategy route.

5. The method according to claim 4, wherein after the step of, determining, by the firewall assembly, the extracted parameter data as the corresponding firewall configuration data, the method further comprises:
setting, by the firewall assembly, the status of the firewall corresponding to the firewall creation event as an effective status, and synchronizing the datum that the firewall corresponding to the firewall creation event is in the effective status to the network server for realizing the use of the firewall corresponding to the firewall creation event.

6. The method according to claim 2, wherein before the step of, sending, by the firewall assembly, the firewall configuration data corresponding to the currently monitored firewall event to the OVN database, the method further comprises:
determining, by the firewall assembly, that the currently monitored firewall event is a firewall deletion event, and obtaining a firewall strategy, a firewall strategy rule and a router of the firewall corresponding to the firewall deletion event from the network server, based on the obtained firewall strategy, firewall strategy rule and router corresponding to the firewall deletion event, constructing parameter data required for constructing the corresponding strategy route, and determining the extracted parameter data as the corresponding firewall configuration information;
correspondingly, the step of, performing, by the OVN database, processing corresponding to the firewall event on the data stored in the OVN database according to the strategy route, comprising:
deleting the data stored by the OVN database that is the same as the strategy route by the OVN database.

7. The method according to claim 6, wherein before the step of, sending, by the firewall assembly, the firewall configuration data corresponding to the currently monitored firewall event to the OVN database, the method further comprises:
determining, by the firewall assembly, that the currently monitored firewall event is a firewall update event, and comparing the firewall strategy rules corresponding to the firewall update event in the network server and the OVN database respectively, when it is determined that a firewall strategy rule needs to be added to the OVN database based on the comparison result, performing correspondingly processing for the firewall creation event according to the currently monitored firewall event; and when it is determined that the firewall strategy rule needs to be deleted from the OVN database based on the comparison result, performing correspondingly processing for the firewall deletion event according to the currently monitored firewall event.

8. The method according to claim 7, wherein the step of, sending by the firewall assembly, the firewall configuration data corresponding to the currently monitored firewall event to the OVN database, comprising:
sending the firewall configuration data corresponding to the currently monitored firewall event to an OVN northbound database by the firewall assembly, and by the OVN northbound database, converting the firewall configuration data into a corresponding strategy route, performing processing corresponding to the firewall event on the data stored by the OVN northbound database according to the strategy route, and after monitoring that the data stored in the OVN northbound database change, by a daemon process of the OVN northbound database, sending the changed data in the OVN northbound database to an OVN southbound database, to instruct the OVN southbound database to store the received data, and send the changed data in the OVN south database to the OVN controller thereafter.

9. The method according to claim 8, wherein before the step of, sending, by the firewall assembly, the firewall configuration data corresponding to the currently monitored firewall event to the OVN database, the method further comprises:
converting, by the firewall assembly, the firewall configuration data corresponding to the currently monitored firewall event into a rule code that capable to be recognized by an OVN driver corresponding to the OVN database;
the step of, converting, by the OVN database, the firewall configuration data into the corresponding strategy route, comprising:
converting, by the OVN northbound database, the firewall configuration data into a corresponding strategy route;
before the step of, storing the received data by the OVN southbound database, the method further comprises:
converting, by the OVN southbound database, the received data into a logical flow table; and
before the step of, storing the received data in the memory by the OVS daemon module, the method further comprises:
parsing the received data into an OVN physical flow table by the OVN daemon module.

10. The method according to claim 9, wherein before the step of, the firewall assembly, the OVN northbound database, the OVN southbound database and the OVN controller sending the data required to be sent, the method further comprises:
encapsulating the data required to be sent into an OVSDB message format.

11. A system for defining a distributed firewall, comprising:
a firewall assembly, configured for monitoring a firewall event in real time, and sending firewall configuration data corresponding to a currently monitored firewall event to an OVN database;
an OVN database, configured for converting the firewall configuration data into a corresponding strategy route, performing processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively;
the OVN controller, configured for sending the received data to an OVS daemon module on the compute node that the OVN controller is located;
the OVS daemon module, configured for storing the received data in a memory to realize forwarding a message.

12. The method according to claim 1, the firewall event comprises at least one of a firewall creation event, a firewall deletion event and a firewall update event.

13. The method according to claim 1, a router for the route is a virtual router or a physical router.

14. The method according to claim 12, when the firewall event is a firewall creation event, the strategy route is stored in the OVN database.

15. The method according to claim 12, when the firewall event is a firewall deletion event, the strategy route is deleted from the OVN database.

16. The method according to claim 12, when the firewall event is a firewall update event, the corresponding data in the OVN database are updated by using the strategy route.

17. The method according to claim 1, Neutron-Fwaas-plugin in a neutron-fwaas plug-in registers a firewall event monitoring mechanism; and
a function code of OVN firewall driver handler is added in the Neutron-Fwass plug-in, to monitor the firewall event by the OVN Firewall Driver Hander.

18. The method according to claim 17, in response to that the OVN Firewall Driver Hander monitors the firewall creation event, the process of executing the corresponding deployment of the firewall creation event comprises:
confirming whether the firewall strategy transmitted by the Neutron Server exists in the network server of the system; in response to yes, continuing to execute, otherwise, exiting;
after confirming that the firewall strategy exists in the network server, confirming whether the firewall strategy rule of the firewall strategy exists in the network server, if yes, continuing to execute, otherwise, exiting; and
after confirming that the firewall strategy rule exists in the network server, confirming whether the router associated with the firewall corresponding to the firewall creation event exists, if yes, continuing to execute, otherwise, exiting.

19. The method according to claim 2, wherein the parameter data comprise an IP, a mac, a port, a protocol and an action.

20. A computer device, wherein the computer device comprises a memory and one or more processors, the memory stores a computer-readable instruction, and the computer-readable instruction, when executed by the one or more processors, causes the one or more processors to implement operations comprising:
monitoring, by a firewall assembly, a firewall event in real time, and sending firewall configuration data corresponding to a currently monitored firewall event to an open virtual network (OVN) database;
converting, by the OVN database, the firewall configuration data into a corresponding strategy route, performing processing corresponding to the firewall event on the data stored in the OVN database according to the strategy route, and sending changed data in the data stored in the OVN database caused by performing processing corresponding to the firewall event on the data stored in the OVN database to OVN controllers located on every compute node respectively;
sending, by the OVN controller, the received data to an open v switch (OVS) daemon module on the compute node that the OVN controller is located, and storing, by the OVS daemon module, the received data in a memory to realize forwarding a message.
